(19) United States
(12) Patent Application Publication
(10) Pub. No.: US 2008/0214135 A1
(43) Pub. Date: Sep. 4, 2008

(54) Methods and apparatus to perform noise cancellation in radios

(76) Inventor: Khurram Muhammad, Dallas, TX (US)

Correspondence Address: TEXAS INSTRUMENTS INCORPORATED, P O BOX 655474, M/S 3999, DALLAS, TX, 75265, US

(21) Appl. No.: 11/712,737

(22) Filed: Mar. 1, 2007

(51) Int. Cl. H04B 1/10

(52) U.S. Cl. 455/296

(57) ABSTRACT

Methods and apparatus to perform noise cancellation in radios are described. According to one example, a receiver includes a front end amplifier to receive and amplify an input signal; a downconverter to downconvert the amplified input signal; a feedback estimator to estimate a noise in the downconverted signal; and a feedback implementer to produce a feedback signal based on the estimated noise and to couple the feedback signal to the front end amplifier.

### TECHNICAL FIELD

The present disclosure pertains to communication systems and, more particularly, to methods and apparatus to perform noise cancellation in radios.

### BACKGROUND

Cellular telephones and other communication equipment include radios that operate using radio frequency (RF) communication, which uses radiated electrical signals to transfer information such as voice and/or data from one location to another via a wireless link. It is commonly the case that the RF signals used to transfer information between a transmitter and a receiver have very high frequencies (e.g., on the order of hundreds or thousands of megahertz). When a receiver of a radio within communication equipment, such as a cellular telephone, receives such high frequency signals, the high frequency signals are commonly downconverted to some intermediate frequency (IF), which may be further converted to a baseband signal, such as a voice signal, for further processing.

The downconversion process is commonly performed using a mixer that receives a subject signal to be downconverted and mixes that signal with a local oscillator (LO) signal, resulting in a version of the subject signal having a lower frequency. In such an example, the downconverted subject signal will have a frequency that is the difference between the original frequency of the subject signal and the frequency of the LO.

Leakage of the LO signal within the receiver, particularly when such leakage is introduced into a low noise amplifier (LNA), degrades the second order intercept point performance (IP2) of the receiver. It is also the case that in a full-duplex transceiver, transmitter output can also parasitically feed in to the receiver for very high output power levels and cause degraded performance of the receiver. Communication standards such as the universal mobile telecommunication system (UMTS) and code-division multiple-access 2000 (CDMA 2000) specify a high level of IP2 performance that is difficult to achieve without addressing the LO leakage as well as the TX output coupling into the receiver and causing higher noise that results in degraded receiver performance.

### BRIEF DESCRIPTION OF THE DRAWINGS

FIG. 1 is a diagram of an example communication system in which the disclosed noise cancellation systems and methods may be implemented.

FIG. 2 is a block diagram showing additional detail of the mobile unit of FIG. 1.

FIG. 3 is a block diagram showing additional detail of an example receiver that may be used to implement the receiver of FIG. 2.

FIG. 4 is a block diagram showing additional detail of an example RF feedback engine that may be used to implement the RF feedback engine of FIG. 3.

FIG. 5 is a schematic diagram of an example receiver showing additional detail of an example RF feedback engine.

FIGS. 6 and 7 illustrate example DC Estimation (DCEST) engines.

FIGS. 8 and 9 illustrate example Blocker Estimation (BEST) engines.

FIG. 10 is a schematic diagram showing an example sigma-delta modulator that may be used in the example receiver of FIG. 5.

FIG. 11 shows a schematic diagram of a generalized sigma-delta modulator engine.

FIG. 12 shows waveforms for local oscillator clocks I+, I−, Q+ and Q− for quadrature down and upconversion.

FIG. 13 is a schematic diagram illustrating operation of a real output mixed signal mixer.

FIGS. 14-16 show further example implementations of complex output mixed signal mixers.

FIGS. 17-19 illustrate examples of differential complex output mixed signal mixers.

FIG. 20 is another example illustrating a general complex output mixed signal mixer.

FIG. 21 is an example illustrating an FIR filter embedding RF feedback.

FIG. 22 is another example illustrating an FIR filter embedding RF feedback.

FIG. 23 is a schematic diagram of a second example receiver including an example RF feedback engine.

FIG. 24 is a flow diagram of an example noise cancellation process.

FIG. 25 is a flow diagram of an example noise cancellation process for handling blockers and interferers.

FIG. 26 is a block diagram of an example processor system on which the systems in the foregoing block diagrams and the foregoing processes may be implemented.

### DETAILED DESCRIPTION

Among other things, this application provides a solution to the problem of degradation of IP2 in the presence of LO leakage as described in “IIP2 and DC Offsets in the Presence of Leakage at LO Frequency,” by I. Elahi, K. Muhammad and P. T. Balsara, Express Briefs, IEEE Transactions on Circuits and Systems II: Analog and Digital Signal Processing, Volume 53, Issue 8, August 2006 Page(s): 647-651.

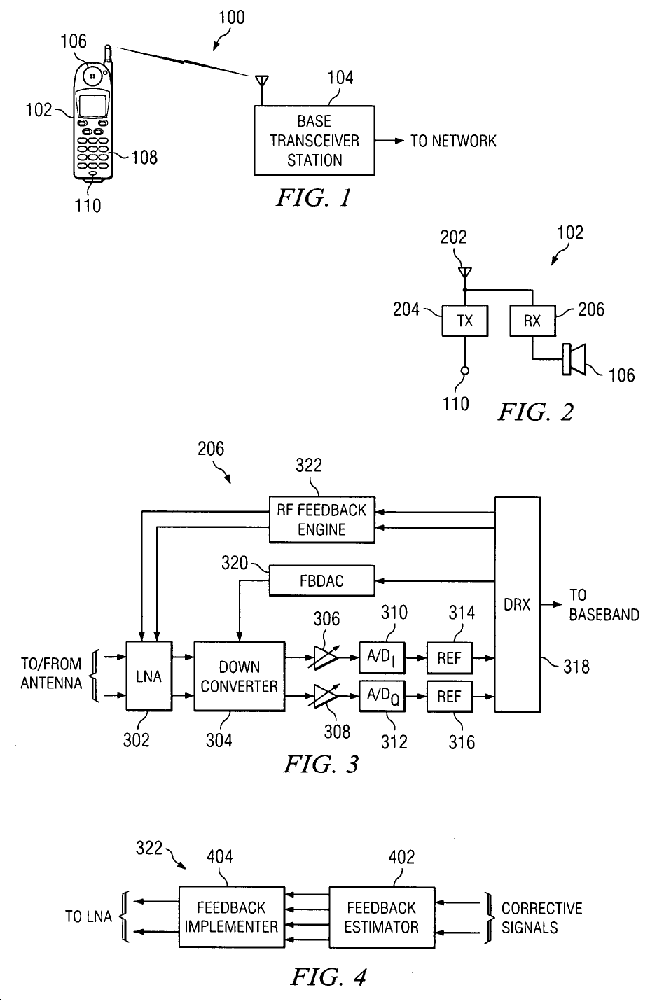

As shown in FIG. 1, an example communication system 100 in which the noise cancellation systems and methods disclosed herein may be used includes a mobile unit 102 and infrastructure 104. The mobile unit 102 may be implemented using a cellular telephone, such as a global system for mobile communications (GSM) telephone, or any other type of telephone that may operate under the principles of frequency division multiple access (FDMA), time-division multiple access (TDMA), and/or code-division multiple access (CDMA). For example, the mobile unit 102 may operate using the advance mobile phone service (AMPS), IS-95, IS-136, or any other suitable protocol. As will be readily appreciated by those having ordinary skill in the art, the mobile unit 102 may include an earpiece speaker 106, a keypad 108, and a microphone 110 in addition to numerous other components such as communications circuits. As described below, the mobile unit 102 may also include a noise cancellation system.

The infrastructure 104 may be implemented using a base transceiver station (BTS) that is configured for wireless communications with the mobile unit 102. The infrastructure 104 may be coupled to one or more other infrastructure units, the plain old telephone system (POTS), or any other suitable network. As with the mobile unit 102, the infrastructure 104 may be implemented as a GSM base station, or as any other FDMA, TDMA, or CDMA compatible base station. In the example of FIG. 1, the communication protocols used by the mobile unit 102 and the infrastructure 104 are not important to this disclosure. Of course, the communication protocols used by the mobile unit 102 and the infrastructure 104 must be compatible for information exchange to be carried out between the mobile unit 102 and the infrastructure 104.

As described below, in the receive path of the mobile unit 102 certain circuitry, such as a mixer LO may cause noise and interference that affects the receive characteristics of the mobile unit 102. For example, intermixing products produced by a downconverter or mixer may affect the IP2 of a receiver when a LO leaks into the LNA and is amplified. As will be readily appreciated by those having ordinary skill in the art, IP2 is a figure-of-merit for linearity or distortion. A higher IP2 means better linearity and less distortion. As described below, feedback techniques may be used to improve the noise performance of a receiver within the mobile unit 102 or, for that matter, any radio in which such noise is present. The feedback techniques include changing loading or signals provided to a front-end low noise amplifier to compensate for noise that will be introduced due to components downstream in the receiver lineup.

As shown in FIG. 2, a mobile unit 102 may include an antenna 202 that is coupled to a transmitter 204 and is also coupled to a receiver 206. In the transmit path, audio from the microphone 110 is processed by the transmitter 204 and broadcast through the antenna to an intended recipient, such as a mobile communications base station. As will be readily appreciated by those having ordinary skill in the art, the transmitter 204 may operate using any number of different communication protocols. Not shown in detail in FIG. 2 is the transmit processing circuitry that may perform analog-to-digital conversion, voice encoding, forward error correction, and/or any other suitable processing that may be required to prepare the voice signals from the microphone 110 for transmission by the antenna 202.

As described in detail below, the receiver 206 includes amplification, downconversion, analog-to-digital conversion, and any other known receive processing needed to convert received RF signals at the antenna 202 to audio signals at the speaker. Additionally, however, the receiver 206 includes noise cancellation processing to control, among other things, the effects of leakage of a LO, such as the receiver LO that is used to downconvert a received RF signal. As described below, such noise cancellation may be implemented using an RF feedback engine that provides feedback signals to a front end LNA. The feedback signals may affect the LNA loading or the LNA input in a manner that corrects for LO leakage.

As shown in FIG. 3, an example receiver 206 includes an LNA 302, a downconverter 304, variable gain amplifiers 306, 308, in-phase and quadrature analog-to-digital (A/D) converters 310, 312, reconstructive filters 314, 316, a digital receiver 318 that post-processes the analog decimated output of the A/D converter after it has been filtered by the reconstructive filters 314, 316, and a feedback digital-to-analog (D/A) converter 320. In addition, as described below in detail, the example receiver 206 includes an RF feedback engine 322, which controls the feedback signal applied to the input or the output of the LNA 302.

The LNA 302 may be any suitable low noise amplifier. For example, the LNA may be a single-stage or a multistage RF amplifier. The RF signals provided to the I and Q mixers in the downconverter 304 may be provided by a single RF output stage of the LNA 302, or by independent output stages of the LNA 302. As described below, the LNA 302 may be fabricated using transistors, inductors, and any other suitable electronic components. Of course the LNA 302 may be constructed using integrated circuits, discrete circuit components, or any suitable combination of integrated circuits and discrete components. The LNA 302 receives an input signal from an antenna, such as the antenna 202 and amplifies the input signal to produce an output signal that is provided to the downconverter. As described in further detail below, the LNA 302 also receives a feedback signal from the RF feedback engine 322 to perform noise cancellation on noise that may be generated subsequently in the receive lineup, such as, for example, noise due to self-mixing of an LO in the downconverter 304, which results in a DC product. As described in detail below, the feedback signal may be applied/coupled to the input of the LNA 302, the output of the LNA 302, or at an intermediate stage input of a multi-stage LNA.

In one example, an RF leakage signal that will result in a DC product may present itself at the input of the LNA 302 due to the power-supply/ground bounce as rail-to-rail swings of a LO are present at inputs of the I and Q mixers in the downconverter 304. Other parasitic coupling paths may also provide ways for the LO signal to appear at the LNA input. The sum of these couplings produces a combination signal with the same frequency as the frequency of the LO signal and a value that is obtained by adding the individual components as a vector sum. The resultant sum will have a certain amplitude and phase and comprises the total “leakage” signal. The total leakage is amplified by the gain in the LNA 302 and presents itself as an amplified signal to the downconverter 304. The downconverter mixes the leakage down to DC using the quadrature LO signals (because the leakage has the same frequency as the LO) and the downconverted leakage appears as a noise signal to the demodulation algorithm in the receiver that detects the received signal.

The downconverter 304 may be any suitable downconverter including a mixer for each of the in-phase and quadrature paths. In one particular example, the downconverter 304 may mix the I and Q RF signals from the output of LNA 302 down to an intermediate frequency. The downconverter 304 also receives feedback signals from the digital receiver 318 to modify and control the behavior of the downconverter 304 in response to the nature of the signals received at the digital receiver. In one example implementation, a single feedback signal can be provided via the feedback D/A converter 320. Alternatively, multiple RF feedback engines may provide multiple feedback signals that are combined together and fed as a composite feedback signal. The combining can occur in a resistive combiner in which each signal is passed through a resistor and the outputs are shorted together to get a superposition of all RF feedback signals. Other known combining solutions may also be used.

The variable gain amplifiers 306, 308 receive the downconverted I and Q signals and amplify the same before the I and Q signals are passed to the A/D converters 310, 312. In a conventional manner, the A/D converters 310, 312 convert the analog I and Q signals from the variable gain amplifiers 306, 308 to a digital format. The conversion from analog to digital results in digital signals that may have, for example, 1 or 8 or 16 bits of resolution. Additionally, the output can have noise shaping introduced in the A/D conversion process.

The digital data representative of the I and Q signals is passed to reconstructive filters 314, 316, which operate on the digital I and Q signals before passing the same to the digital receiver 318.

The digital receiver 318 may be for example, any suitable digital receiver capable of processing I and Q digital signals. For example, the digital receiver 318 may perform channel selection, resampling, further downconversion, and/or other front end processing. The digital receiver 318 passes the processed I and Q signals to a baseband receiver for further processing and, ultimately, conversion to audio that may be presented to a user at the speaker 106 of the mobile unit 102.

The digital receiver 318 outputs correction signals that may, in one example, be the output from the main receiver reconstructive filter, such as, the reconstructive filters 314, 316. The correction signals are coupled to the RF feedback engine 322, which, as described below, processes such signals and generates feedback signals that are used to load the LNA 302 or, in another example, to affect the input to the LNA 302. Of course, more than one such RF feedback engine may be used to target different noise sources.

In another alternative example, the corrective signals may be taken from the outputs of the A/D converters 310, 312 and passed to the RF feedback engine 322. One consideration in selection of the source of the corrective signals is the data rate of the signals that are selected. The output signals from the A/D converters 310, 312 are higher in frequency (i.e., have a higher data rate) than the signals taken from the reconstructive filters 314, 316 because most applications use sigma-delta modulator engines in A/D converters that perform over-sampling. Thus, for practical reasons relevant to implementation, the lower frequency signals from the reconstructive filters 314, 316 may be selected.

The feedback D/A converter 320 converts digital feedback signals generated by the digital receiver 318 to alter the performance of the downconverter 304 to analog signals that may be used to influence the operation of the downconverter 304. The operation of the feedback D/A converter 320 and the signals it receives is known and, therefore, will not be addressed in further detail herein.

As noted above, the RF feedback engine 322 receives corrective signals from either the digital receiver 318 or the A/D converters 310, 312 and processes the same to produce feedback signals that affect the operation of the LNA 302. That is, the feedback signals produced by the RF feedback engine 322 alter the operation of the LNA 302 to compensate for any LO leakage that may cause self-mixing in the downconverter 304 to cause generation of a DC signal or a near-DC signal. As described below in detail, the RF feedback engine may also be used to selectively create notches to eliminate other interference such as blockers that may influence the receiver. These notches are created through the influence of the RF feedback engine 322 on the LNA 302.

FIG. 4 shows additional detail regarding one possible example implementation of the RF feedback engine 322. As shown in FIG. 4, corrective signals are provided to a feedback estimator 402 that produces output signals that are coupled to a feedback implementor 404. As described below in detail, the feedback estimator 402 determines the LNA influence needed to correct for any DC offset, which may be due to LO leakage or any other source, and/or any blocker that the system may determine is present. In one example, the signals from the feedback estimator 402 are sigma-delta modulated pulses that may be generated by one or more sigma-delta modulator engines.

After the necessary LNA influence is determined to correct for noise such as LO leakage or blockers, the feedback estimator 402 passes such feedback signals to the feedback implementer 404. As described below, using, for example, mixed mode mixers, the feedback implementer 404 receives the signals from the feedback estimator 402, which may be sigma-delta modulated, and combines these signals with pulses having the LO frequency and having sine and/or cosine formatted phases in the form of positive and negative in-phase and quadrature pulse trains. The results of the combination influence the operation of the LNA 302 by, for example, altering the input signal seen by the LNA 302 or, in another example implementation, altering the signal loading on lines providing the antenna signals to the input of the LNA 302 or altering the signal at the output of the LNA 302 to affect the operation of the downconverter 304.

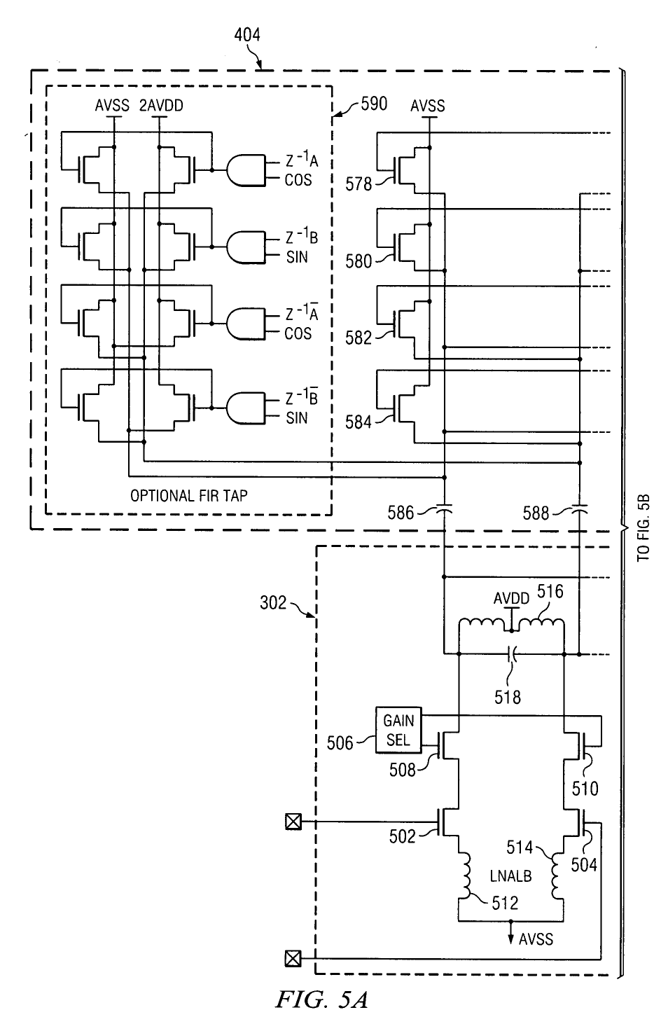

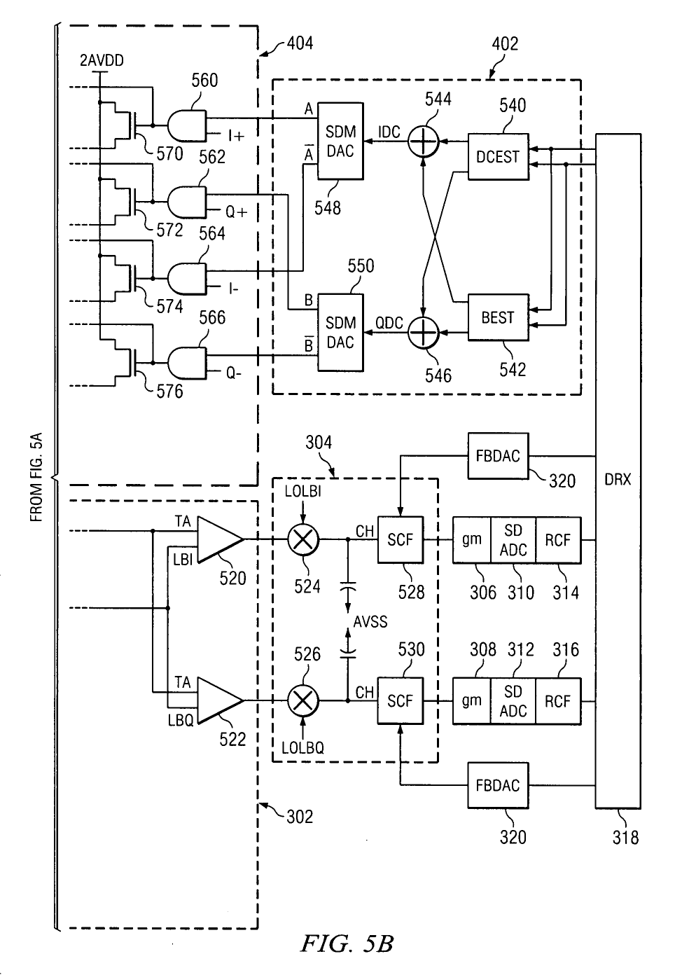

FIG. 5 shows one example implementation of the system described in conjunction with FIGS. 3 and 4, but shows additional detail regarding certain aspects. As shown, the LNA 302 includes input transistors 502 and 504 to which the signals from the antenna (e.g., the antenna 202) are coupled. A gain selector 506 controls gain setting transistors 508, 510 that are coupled to the input transistors 502, 504. Inductors 512, 514 are coupled between respective input transistors 502, 504 and ground (AVSS). A supply inductor 516 is coupled in parallel with a capacitor 518 and is further coupled to a voltage supply (AVDD). Inputs to transistor amplifiers 520, 522 are provided from each side of the capacitor 518.

The outputs from the transistor amplifiers 520, 522 are coupled to the downconverter 304, which includes first and second mixers 524, 526, one of which is fed with an in-phase version of the LO and one of which is fed with a quadrature version of the LO. The outputs from the mixers 524, 526 are coupled to switched capacitor filters 528, 530.

As described above, the outputs of the downconverter 304 are coupled to the variable gain amplifiers 306, 308, which feed A/D converters 310, 312. The outputs of the A/D converters 310, 312 are coupled to the reconstructive filters 314, 316.

As shown in FIG. 5, the feedback estimator 402 includes a DC estimator 540 (DCEST), a blocker estimator 542 (BEST), adders 544, 546, and sigma-delta modulator engines 548, 550.

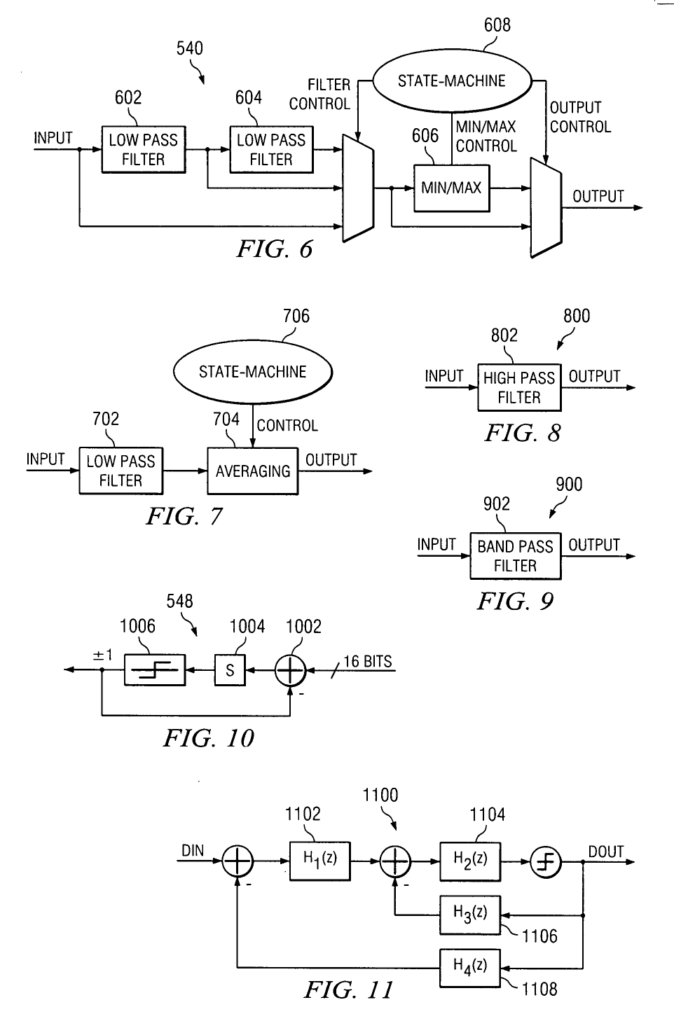

The DC estimator 540 may be implemented using the example shown in FIG. 6. The DC estimator 540 of FIG. 5 produces outputs reflective of the leakage LO such that the output of the DC estimator 540 can be used to provide signals to the LNA 302 to compensate for the leakage LO, which ultimately results in DC signals. The block diagram shown in FIG. 6 shows a programmable cascade of low-pass filters 602, 604 followed by a min/max unit 606 that operates under the command of a state-machine 608. The state-machine 608 can be controlled by a micro-processor that, for example, controls the operation of mobile unit 102. The min/max unit 606 computes the minimum and the maximum values of the signal that passes through it. When the DC value of a signal needs to be estimated, the input data is passed through the min/max unit 606 so that it can calculate the minimum and the maximum values. At the end of the sequence, the state-machine 608 reads the minimum and maximum values and computes the difference between the two to obtain the peak-to-peak signal value and the sum to obtain average value. The average value is an estimate of the DC signal. The purpose of low-pass filters 602, 604 is to help obtain a better average value, i.e., to reduce the noise of the DC estimate. The average value thus can be computed over several streams of data under the control of the state-machine 608 that resets the min/max unit 606 at the end of each estimate. The final DC value can be calculated by taking an average value of all the average values obtained in each run. The filters 602, 604 shown can have programmable pass-bands that may be controlled by the state-machine 608.

FIG. 7 shows an alternate approach to calculating the DC value, which may be used in the DC estimator 540. An input signal is passed through a low pass filter 702 and provided to an averaging unit 704, which can be operated under the control of a micro-processor or state machine 706, as described above. The average value produced by the averager 704 is a representative of the DC signal. The purpose of the low pass filter 702 is to restrict the noise seen by the averaging unit so as to enable it to obtain a superior estimate of the DC value. The pass band of the low pass filter 702 may be programmable. It is conceivable that to assist the filter settling, the pass band is increased in the initial part of the data and tightened subsequently to allow better estimation. Not shown in FIGS. 6 and 7 are possibilities of applying windowing functions on the sequences on which the averaging are performed, however, it is clear to those having ordinary skill in the art that techniques used to improve the accuracy of estimate of DC value can be readily applied.

The blocking estimator 542 may be implemented using one of the circuits shown in FIG. 8 or 9. The blocking estimator 542 processes the input signals to develop output signals representative of blockers that may be present within range of the receiver. The signals representative of the blockers may then be upconverted to the RF carrier frequency using the LO and provided to the LNA 302, such that blockers can be notched out by the LNA 302 according to the signals provided thereto, which affect LNA loading or LNA input attenuation/loading.

FIG. 8 shows one example of blocker estimator 800 including a high pass filter 802. The output of this filter 802 has the frequencies carrying the information in the input signal removed from its output. Hence, when upconverted and fed to the LNA 302, no feedback is made in the band of interest while only the signals outside of the band of interest are fed back for the purpose of canceling out the blockers.

FIG. 9 shows a second example 900 including a band pass filter 902. This example allows feeding adjacent channel frequencies of interest to the upconverter whose output is subsequently fed back to the LNA 302. An advantage of this option is that this allows good stability of the blocker cancellation loop. High pass or low pass transfer functions can be realized using finite impulse response (FIR) or infinite impulse response (IIR) structures.

Returning back to FIG. 5, the in-phase outputs of each of the DC estimator 540 and the blocking estimator 542 are coupled to the adder 544. Similarly, the quadrature outputs of each of the DC estimator 540 and the blocking estimator 542 are coupled to the adder 546. Thus, the signals output from the adders 544, 546 represent both leakage LO (DC estimates) and blockers (blocker estimates) to be corrected-for in the LNA 302.

The outputs from the adders 544, 546 are coupled to the sigma-delta converters 548, 550, which are also referred to herein as sigma-delta modulator engines. The detail of a representative one of the sigma-delta converters (e.g., the sigma-delta converter 548) is shown in FIG. 10. As shown in FIG. 10, bits representative of information, such as bits output from the adder 544, are coupled to an adder 1002, which receives a feedback connection that is subtracted from the value represented by the 16 bits. The difference generated by the adder 1002 is coupled to an integrator 1004, which integrates the difference signal over a period of time.

The output from the integrator 1004 is coupled to comparator 1006, which makes each bit a value of one or negative one based on the value of the integrator output. The output of the comparator 1006 is fed back to the adder 1002 where it is subtracted from the incoming signal. The output of the sigma-delta converter 548 is an over-sampled digital version of the input that is represented by a single-bit. It is also possible to construct a multi-bit digital output signal. FIG. 11 shows a general version of the sigma-delta converter.

As shown in FIG. 11, the sigma-delta modulator engines 548, 550 convert the input word-length from many-bits to 1 bit output that is noise shaped by the noise transfer function implemented in the sigma-delta modulator engine. The output of the sigma-delta modulator engines 548, 550 is digital. FIG. 11 shows a sigma-delta modulator engine 1100 that produces a 1 bit output DOUT that represents the information in the multi-bit input signal DIN using a high over-sampling ratio. The transfer functions H₁(z), H₂(z), H₃(z) and H₄(z) (shown at reference numerals 1102, 1104, 1106, and 1108) are user selected to provide the necessary signal and noise transfer functions while keeping the modulator stable. These transfer functions may be programmable to allow altering the shape of the signal and/or noise transfer functions.

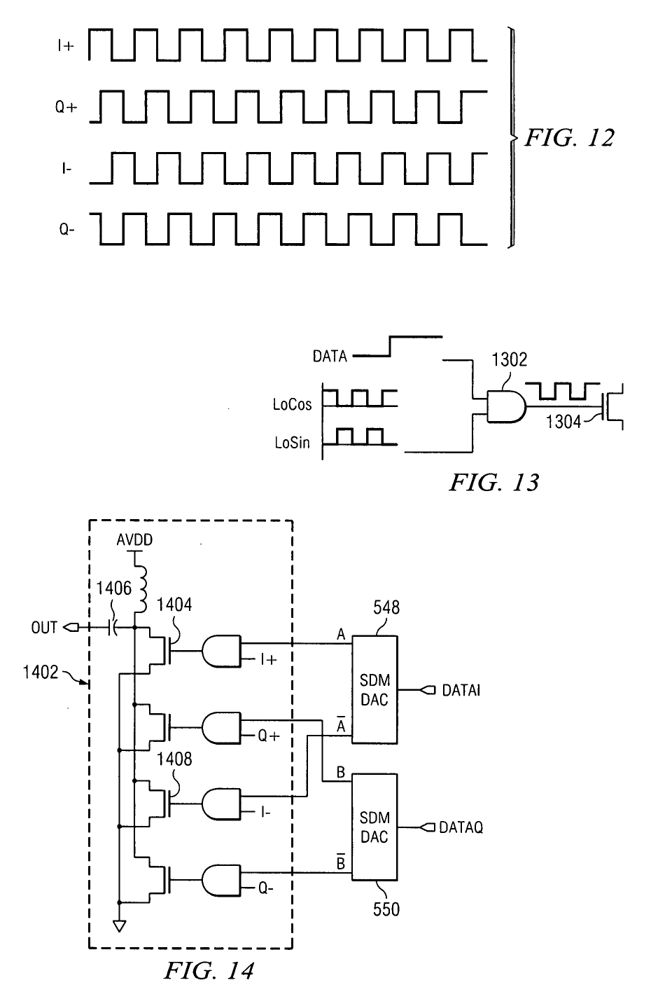

Returning to FIG. 5, the output from the sigma-delta converters 548, 550, as well as their complements, are coupled to the feedback implementer 404. As shown in FIG. 5, the feedback implementer 404 may be implemented using AND gates 560, 562, 564, and 566. The output from the sigma-delta converters 548, 550 are coupled to one input of the AND gates 560, 562, 564, 566. The remaining terminals of the AND gates 560, 562, 564, 566 are coupled to positive and negative LO signals represented by I+, I−, Q+ and Q− that correspond to the four phases of the LO separated by 90 degrees. These signals are shown in FIG. 12.

The outputs of the AND gates 560, 562, 564, 566 are coupled to transistors 570, 572, 574, 576, 578, 580, 582, 584 that are coupled between either ground (AVSS) and a first coupling capacitor 586 or between two times the supply voltage of the LNA (2AVDD) and a second coupling capacitor 588. These mixed mode mixers are used to influence the voltage supplied to the LNA 302 via the capacitors 586, 588. The choice to 2AVDD is arbitrary; this voltage is twice the common mode voltage at the LNA 302 output.

The combination of the AND gates and the transistors shown in FIG. 5 in the feedback implementer 404 may be referred to as a mixed mode mixer. Further detail regarding a mixed mode mixer (or upconverting mixer) is shown in FIG. 13. A data signal has a relatively low frequency compared to the LO frequency, thus, when the two signals are provided to an AND gate 1302, the resulting output signal has the frequency of the LO signals when the data signal is high. The output signal has a zero value when the data signal is low. The output from the AND gate 1302 is applied to the gate of a transistor 1304, which is used to influence the loading of the LNA 302 via the capacitors 586, 588.

The feedback implementer 404 must not feed appreciable noise back to the front-end (i.e. the LNA 302). The output of the feedback implementer 404 can be connected either at the input of the LNA 302, an intermediate input node in a multi-stage LNA or at the output of the LNA 302. There are many ways to construct a low-noise feedback implementer. Some are described in the following.

FIG. 14 shows one technique of constructing a feedback implementer 1402. The baseband representation of the feedback signal is in quadrature domain represented by DATAI+j DATAQ and consists of the output of the feedback engine (j distinguishes the imaginary part). It may also be the sum of outputs of multiple feedback engines. The signal is converted from a multi-bit representation at a lower data rate to an over-sampled single-bit output stream. When the single-bit output is a 1, I+is gated out to allow an RF output that is in-phase with I+ by turning on the top transistor 1404. This output is coupled to the LNA 302 input through a capacitor 1406 that may act as an attenuator at the RF carrier frequencies, thereby allowing the signal and noise power to be lowered in power at the LNA 302 input. When the single bit output is 0, I− is gated out to create an RF signal that is in-phase with I− and applied via transistor 1408 to the LNA 302 input after undergoing the attenuation in the coupling capacitor 1406. The same is true for the Q path which can also generate RF signal in-phase with Q+, when the single-bit output of the sigma-delta converter is 1, and Q− when it is 0.

The superposition of the I and Q output produces a resulting RF signal that is the vector sum of the I and Q outputs. Its amplitude is controlled by the duty-cycle of 1's in the output of the sigma-delta converters 548, 550. The system shown in FIG. 14 implements an upconverting mixer that converts baseband data to an RF signal whose amplitude is controlled by the duty cycle of 1's (large positive I) or 0's (large negative I) and phase is controlled by the ratio of the duty cycle of 1's of I-channel versus the Q-channel data.

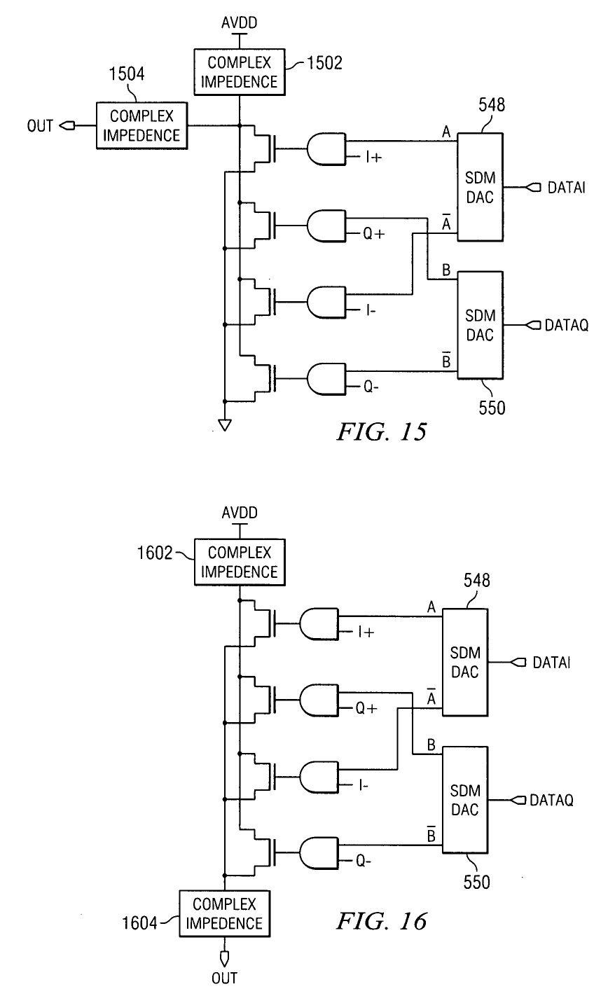

As shown in FIG. 15, the coupling of the upconverting mixer can be any complex impedance 1502, 1504 consisting of a combination of resistors, inductors and capacitors to provide high Q filtering at the output, thereby creating a purer RF feedback signal. It may also provide attenuation at the RF carrier frequency to reduce the amount of noise feedback to the LNA 302.

Another example of the upconverting mixer is shown in FIG. 16 that inputs the quadrature digital signal DATAI+j DATAQ and upconverts it to an RF carrier frequency. A wide range of complex impedances 1602, 1604 can be deployed to provide attenuation and band pass filtering to the output of the mixer.

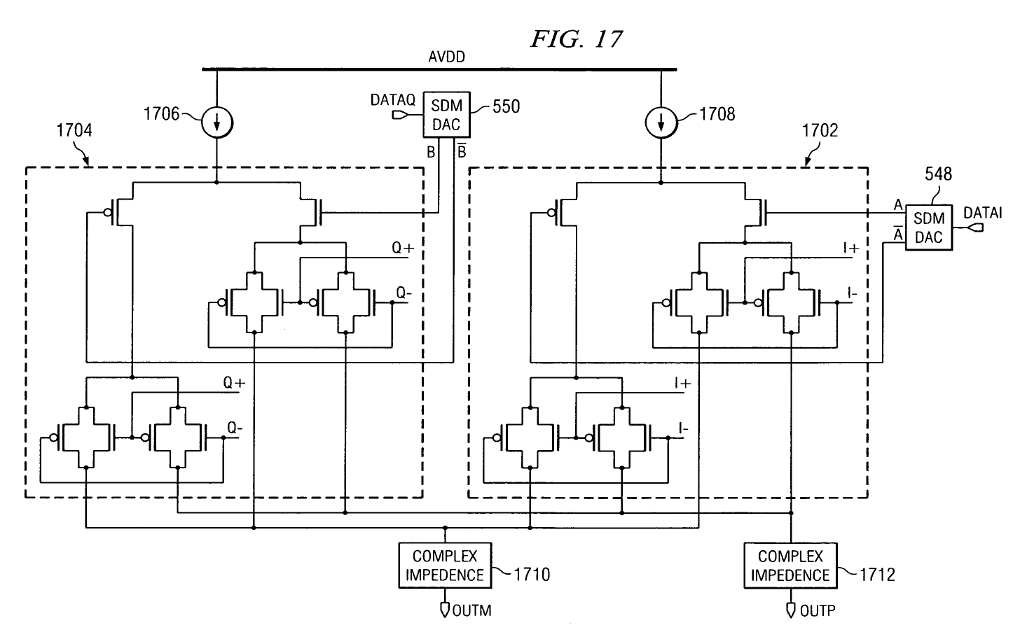

FIG. 17 shows another upconverting mixer that is a feedback implementer. Current steering DACs 1702 and 1704 are utilized to steer current from current sources 1706, 1708 to OUTP or OUTM depending on the output of the sigma-delta converters 548, 550. If the output of the converter is a 1, I+ going high steers the current to OUTP while I− steers current to OUTM. The output sees an RF signal with an envelope of +1. When the sigma-delta converter outputs a 0, I+ going high steers the current to OUTM while I− going high steers the current to OUTP. Hence, an RF signal with envelope of −1 is created. A similar setup exists for the Q-channel and shares the output. Hence, a resulting vector signal can be created whose amplitude is controlled by the duty cycle of 1's or 0's in the I and Q paths, while the phase is controlled by the ratio of the duty cycles. In other words, because the sigma-delta converters 548, 550 converts the input digital values to streams of 1's representing the magnitude by duty cycles of 1's and 0's, the magnitude and phase of the output RF signal can be controlled by the input DATA=DATAI+j DATAQ such that the RF signal magnitude is proportional to absolute value of DATA and the phase is controlled by the phase of DATA. The RF output signal can be coupled to the LNA 302 input through complex impedances 1710, 1712 that consists of resistors, inductors and/or capacitances that provide attenuation and high-Q function at the RF carrier frequency. The circuit of FIG. 17 produces a differential RF signal.

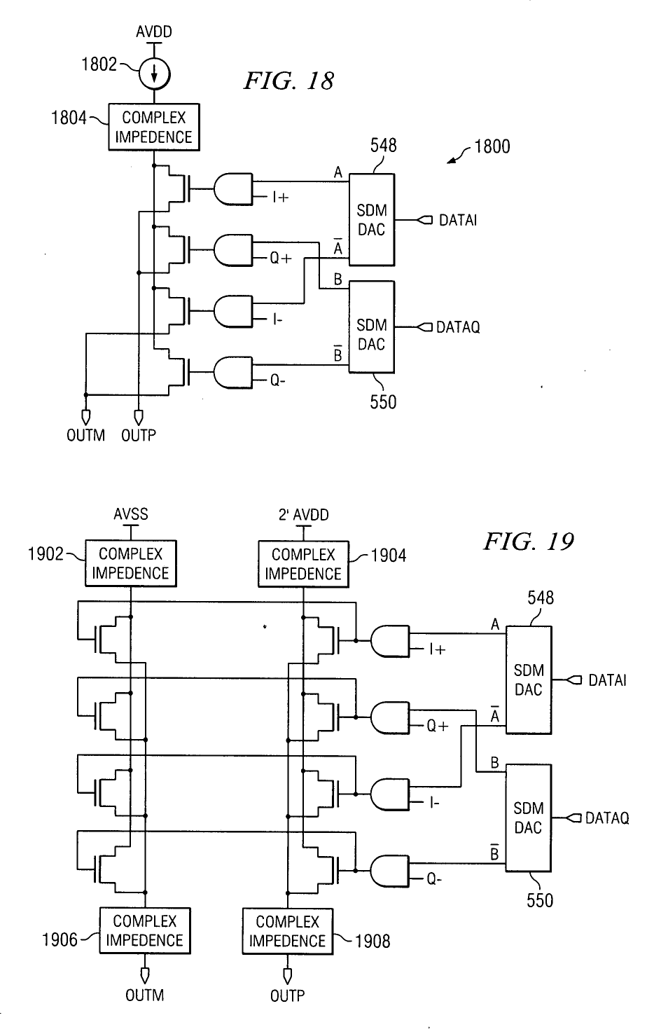

FIG. 18 shows another differential output RF upconverter 1800. A 1 at the sigma-delta converter 548 output routes the I+ signal from a current source 1802 through a complex impedance 1804 to OUTP while a 0 routes I− from the current source 1802 through the complex impedance 1804 to OUTM. Similar arrangement exists for the Q-channel data that routes Q+ to OUTP and Q− to OUTM for 1 and 0 outputs, respectively, via the current source 1802 and the complex impedance 1804.

FIG. 19 shows another example of an upconverting mixer 1900 that upconverts DATAI+j DATAQ to an RF carrier frequency. The upconverting mixer 1900 uses a similar configuration to those described above, but uses voltage supplies of AVSS and 2 AVDD that are connected through complex impedances 1902 and 1904 and 1906 and 1908.

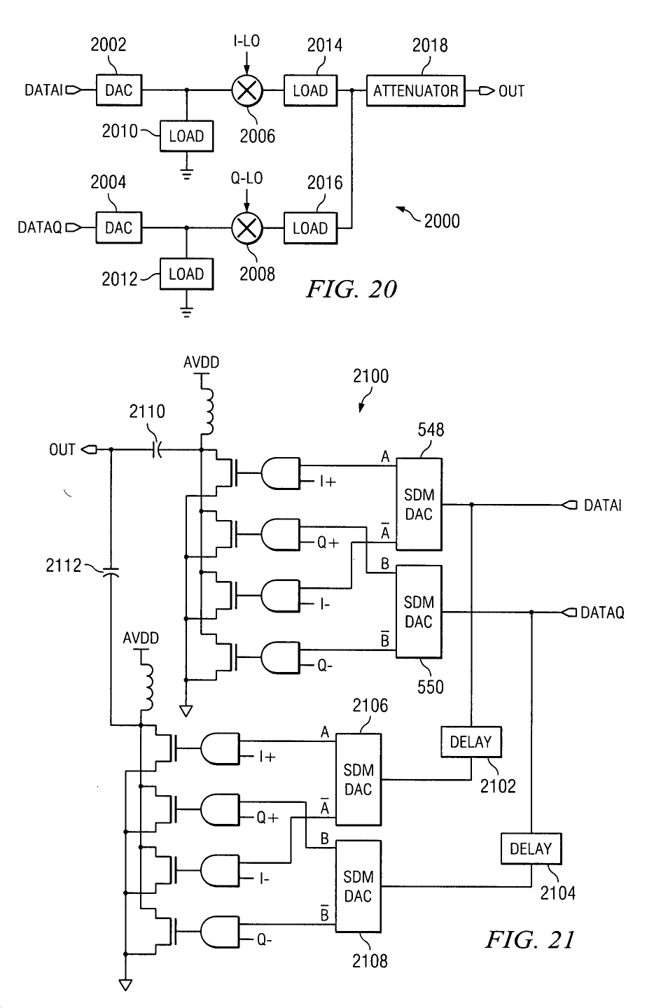

FIG. 20 shows a generic upconverting mixer 2000 that includes D/A converters 2002, 2004 whose outputs are upconverted to RF carrier frequency by mixers 2006, 2008. If implemented as a current steering structure, loads 2010, 2012 convert the D/A output from current to voltage. The loads 2010, 2012 may also implement filtering to severely limit noise. If implemented as a voltage D/A, the loads 2010, 2012 may only be used to severely limit noise. The I/Q outputs are unconverted using a conventional quadrature upconversion scheme and combined at the output of optional loads 2014, 2016. In their simplest forms, the loads 2014, 2016 may be capacitors or resistors or tank circuits with center at the RF carrier frequency. An attenuator 2018 is provided to reduce the noise input to the LNA 302 through the feedback path. Of course, the attenuator 2018 will also attenuate the feedback signal power, however, this is of little consequence as the LNA input usually accepts small input power levels.

Also shown in FIG. 5 is an optional FIR tap filter 590. As noted above the subject system can correct for leakage LO, but can also eliminate blockers. The optional FIR tap filter 590 is the technique used to eliminate blockers by affecting LNA loading. Specifically, the optional FIR tap filter 590 includes the mixed mode mixer configurations that are driven with signals used to null out blockers.

FIG. 21 shows an example FIR filter 2100, such as may be used at reference numeral 590 of FIG. 5, created by phase delaying the input signal. Through the use of delays 2102, 2104, a delayed replica copy of DATA=DATAI+j DATAQ is provided to a replica feedback implementer using sigma-delta modulator engines 2106, 2108. The combined output, which is provided by two capacitors 2110, 2112 sees a transfer function of 1+z⁻¹ that creates a notch at fs/2, where fs is the sampling frequency corresponding to z⁻¹.

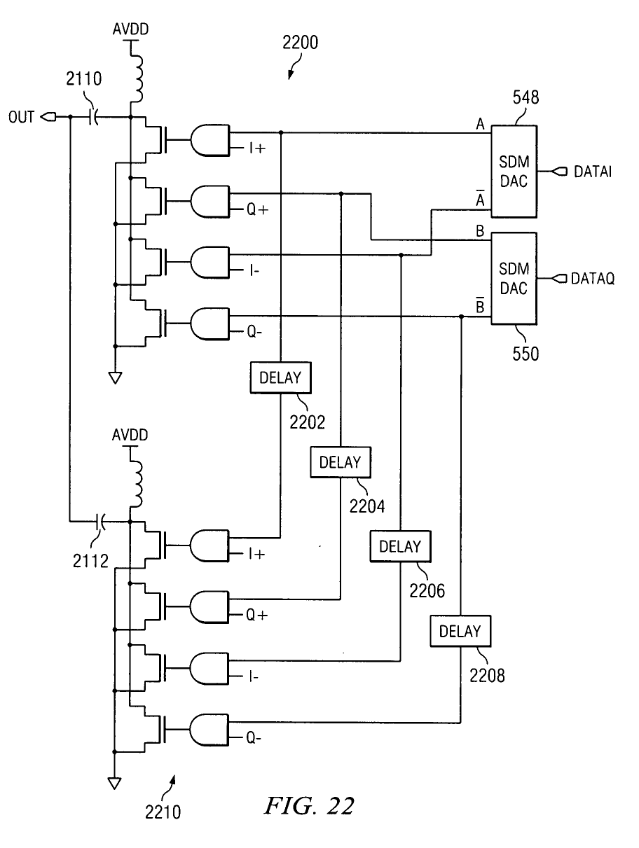

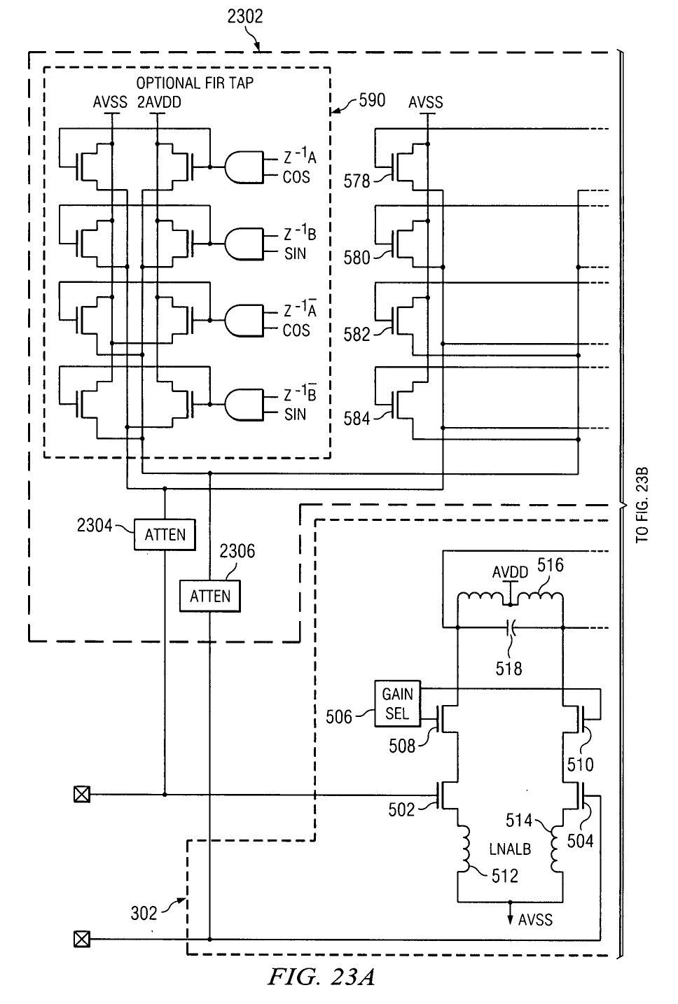

FIG. 22 shows another example implementation of an FIR function 2200 in which the outputs of the sigma-delta modulator engines 548, 550 are delayed by delays 2202, 2204, 2206, 2208 and fed to a replica upconverter 2210. In this example, the composite out obtained by summing the RF signals at the produced by the two upconverters sees a transfer function of 1+z⁻¹ that creates a notch at fs/2, where fs is the sampling frequency corresponding to z⁻¹. In this example, because the outputs of sigma-delta converters 548, 550 are oversampled by a factor of N, the inferred fs is also greater by N. The fundamental approach of creating a notch in the output response is to add a delayed replica of the synthesized RF feedback signal. The location of the notch is determined by the amount of the delay.

Creating notches in the feedback signal can be important for many reasons. One example in which it is advantageous is if the blocker estimator is used to cancel out the TX leakage. In a full-duplex system, when the transmitter is producing very high output power levels, a parasitic leakage signal is present at the receiver input. Although, it may be attenuated by 40-60 dB, it is still large enough to degrade the receiver performance. Because the transceiver has a knowledge of what it is transmitting, it can synthesize the same signal to be fed to feedback implementer with the goal of canceling the TX leakage at the LNA input and saving the receiver from degraded performance.

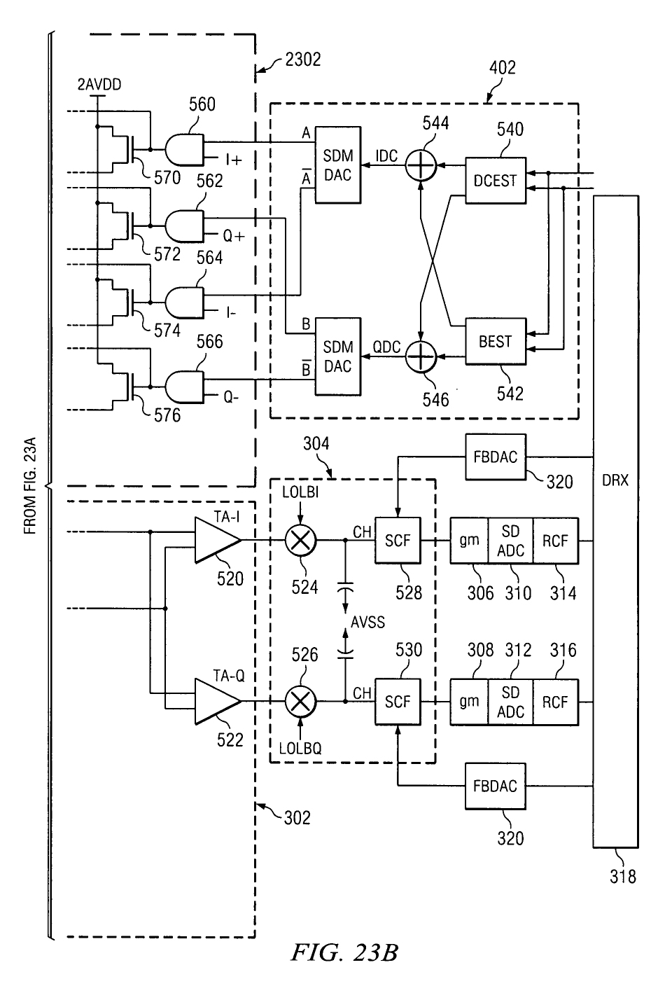

Turning now to FIG. 23, a second example receiver including an alternate RF feedback engine is shown. The arrangement of FIG. 23 is very similar to the arrangement of FIG. 5. Like reference numerals have been used in FIG. 23 to represent similar or identical components to those found in FIG. 5. The feedback implementer 2302 differs from the example provided in FIG. 5 due to the manner in which the LNA 302 is influenced to correct for leakage LO and blockers. While, as described above, the example of FIG. 5 corrected for leakage LO and blockers by influencing the loading of the LNA 302, the example of FIG. 23 influences the input of the LNA 302 through attenuators 2304, 2306. That is, according to FIG. 23, leakage LO and blockers are corrected-for by variably attenuating or loading the input to the LNA 302. As with the example of FIG. 5, the example of FIG. 23 can orthogonally influence the LNA 302 to achieve the desired affect that corrects for leakage LO and blockers.

Having described the mixer constructed using a single bit output it is possible to use a multi-bit sigma-delta converter instead. As an example, a MASH sigma-delta engine can be used to produce a multi-bit over sampled sigma-delta noise shaped output. To each output bit an independent feedback implementer can be connected. The output of all the feedback implementers can be combined together to produce the total feedback signal. This composite signal can be fed to the LNA input using a complex impedance that may be a simple resistive or capacitive attenuator, or a combination of resistors, inductors and capacitors that provide a high-Q RF filtering together with the desired attenuation function.

Having described the architecture of example systems that may be used to perform noise cancellation, a noise cancellation process is described. Although the following describes a process through the use of a flow diagram having blocks, it should be noted that the process may be implemented in any suitable manner. For example, the processes may be implemented using, among other components, software, or firmware executed on hardware. However, this is merely one example and it is contemplated that any form of logic may be used to implement the systems or subsystems disclosed herein. Logic may include, for example, implementations that are made exclusively in dedicated hardware (e.g., circuits, transistors, logic gates, hard-coded processors, programmable array logic (PAL), application-specific integrated circuits (ASICs), etc.) exclusively in software, exclusively in firmware, or some combination of hardware, firmware, and/or software. For example, instructions representing some or all of the blocks shown in the flow diagram may be stored in one or more memories or other machine readable media, such as hard drives or the like. Such instructions may be hard-coded or may be alterable. Additionally, some portions of the process may be carried out manually. Furthermore, while each of the processes described herein is shown in a particular order, those having ordinary skill in the art will readily recognize that such an ordering is merely one example and numerous other orders exist. Accordingly, while the following describes example processes, persons of ordinary skill in the art will readily appreciate that the examples are not the only way to implement such processes.

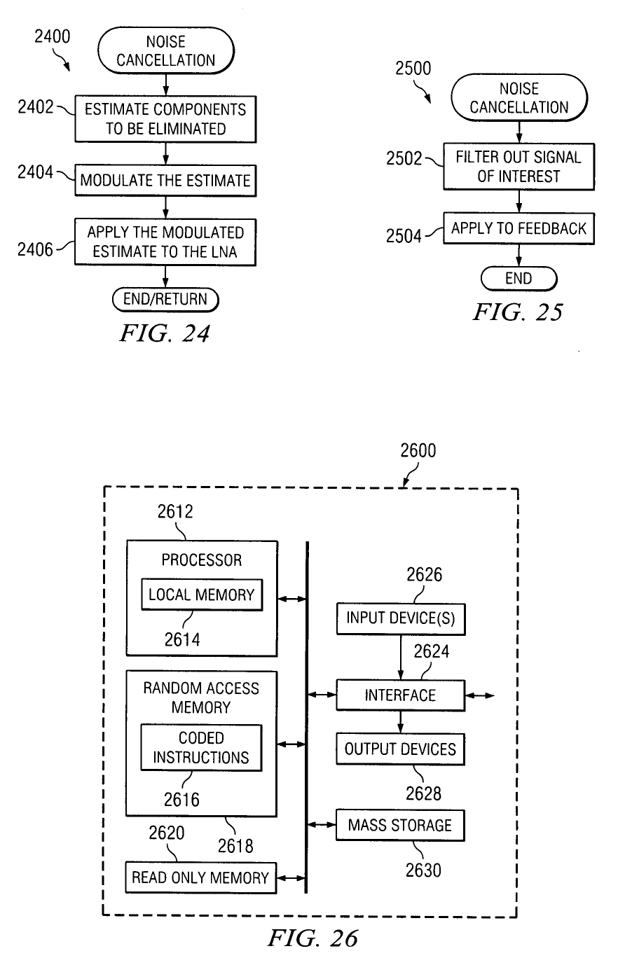

An example noise cancellation process 2400 is illustrated in FIG. 24. The process 2400 may be implemented using one or more software programs or sets of instructions or codes that are stored in one or more memories (e.g., the memories 2604, 2618, and/or 2620 of FIG. 26) and executed by one or more processors (e.g., the processor 2612). However, some of the blocks of the process 2400 may be performed manually and/or by some other device. Additionally, although the process 2400 is described with reference to the flowchart of FIG. 24, persons of ordinary skill in the art will readily appreciate that many other methods of performing the process 2400 may be used. For example, the order of many of the blocks may be altered, the operation of one or more blocks may be changed, blocks may be combined, and/or blocks may be eliminated.

An example noise cancellation process 2400 is shown in FIG. 24. The process 2400 estimates components that are to be eliminated from the receiver lineup (block 2402). For example, the process 2400 determines an estimate of a DC component such as leakage LO or determines and estimate of a blocker that is to be removed.

The process 2400 then modulates the estimate (block 2404) using, for example, sigma-delta modulation. The sigma-delta modulated estimate is then applied to the LNA (block 2406). As noted above, the modulated estimate may be applied by varying LNA loading or the attenuation provided in a line supplying an input signal to the LNA.

FIG. 25 shows another example process for noise cancellation 2500 including blocker elimination. The signal of interest that carries the information to be demodulated is filtered out (block 2502) and the remaining signal is fed back to the feedback implementer (block 2504).

FIG. 26 is a block diagram of an example computer 2600 capable of implementing the apparatus and methods disclosed herein. The computer 2600 can be, for example, a processing device, a server, a personal computer, a personal digital assistant (PDA), an Internet appliance, a DVD player, a CD player, a digital video recorder, a personal video recorder, a set top box, a cellular or mobile telephone, or any other type of computing device.

The system 2600 of the instant example includes a processor 2612 such as a general purpose programmable processor. The processor 2612 includes a local memory 2614, and executes coded instructions 2616 present in the local memory 2614 and/or in another memory device. The processor 2612 may execute, among other things, machine readable instructions implementing the process represented in FIGS. 24 and 25. The processor 2612 may be any type of processing unit, such as one or more microprocessors from the Texas Instruments OMAP® family of microprocessors. Of course, other processors from other families are also appropriate.

The processor 2612 is in communication with a main memory including a volatile memory 2618 and a non-volatile memory 2620 via a bus 2622. The volatile memory 2618 may be implemented by Static Random Access Memory (SRAM), Synchronous Dynamic Random Access Memory (SDRAM), Dynamic Random Access Memory (DRAM), RAMBUS Dynamic Random Access Memory (RDRAM) and/or any other type of random access memory device. The non-volatile memory 2620 may be implemented by flash memory and/or any other desired type of memory device. Access to the main memory 2618, 2620 is typically controlled by a memory controller (not shown).

The computer 2600 also includes an interface circuit 2624. The interface circuit 2624 may be implemented by any type of interface standard, such as an Ethernet interface, a universal serial bus (USB), and/or a third generation input/output (3GIO) interface.

One or more input devices 2626 are connected to the interface circuit 2624. The input device(s) 2626 permit a user to enter data and commands into the processor 2612. The input device(s) can be implemented by, for example, a keyboard, a mouse, a touchscreen, a track-pad, a trackball, an isopoint and/or a voice recognition system.

One or more output devices 2628 are also connected to the interface circuit 2624. The output devices 2628 can be implemented, for example, by display devices (e.g., a liquid crystal display, a cathode ray tube display (CRT)), by a printer and/or by speakers. The interface circuit 2624, thus, typically includes a graphics driver card.

The interface circuit 2624 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The computer 2600 may also include one or more mass storage devices 2630 for storing software and data. Examples of such mass storage devices 2630 include flash memories, floppy disk drives, hard drive disks, compact disk drives and digital versatile disk (DVD) drives.

As an alternative to implementing the methods and/or apparatus described herein in a system such as the device of FIG. 26, the methods and or apparatus described herein may be embedded in a structure such as a processor and/or an ASIC (application specific integrated circuit).

Although certain apparatus constructed in accordance with the teachings of the invention have been described herein, the scope of coverage of this patent is not limited thereto. On the contrary, this patent covers every apparatus, method and article of manufacture fairly falling within the scope of the appended claims either literally or under the doctrine of equivalents.

What is claimed is:

1. A method of eliminating noise in a receiver, the method comprising:
receiving a downconverted radio frequency signal from a front end amplifier;
estimating a noise in the downconverted radio frequency signal;
producing a feedback signal based on the estimated noise; and
coupling the feedback signal to the front end amplifier.

2. The method of claim 1, wherein the front end amplifier comprises a low noise amplifier.

3. The method of claim 1, wherein estimating the noise in the downconverted radio frequency signal comprises estimating a DC component in the downconverted radio frequency signal.

4. The method of claim 3, wherein estimating the noise in the downconverted radio frequency signal comprises estimating a blocking RF signal component in the downconverted radio frequency signal.

5. The method of claim 4, further comprising adding the estimated blocking RF signal component and the estimated DC component.

6. The method of claim 5, further comprising performing sigma-delta modulation on the sum of the estimated blocking RF signal component and the estimated DC component.

7. The method of claim 1, wherein coupling the feedback signal to the front end amplifier comprises upconverting the feedback signal and coupling the upconverted feedback signal to the front end amplifier.

8. The method of claim 7, wherein coupling the feedback signal to the front end amplifier comprises coupling the feedback signal to the front end amplifier input.

9. The method of claim 7, wherein coupling the feedback signal to the front end amplifier comprises performing a logical AND operation between the feedback signal and a digital signal having a local oscillator frequency.

10. The method of claim 9, wherein the feedback signal is coupled to the front end amplifier through a complex impedance.

11. The method of claim 7, wherein coupling the feedback signal to the front end amplifier comprises use of a current steering digital to analog converter.

12. The method of claim 7, wherein the feedback signal is a complex signal.

13. A receiver comprising:
a front end amplifier to receive and amplify an input signal;
a downconverter to downconvert the amplified input signal;
a feedback estimator to estimate a noise in the downconverted signal; and
a feedback implementer to produce a feedback signal based on the estimated noise and to couple the feedback signal to the front end amplifier.

14. The receiver of claim 13, wherein the front end amplifier comprises a low noise amplifier.

15. The receiver of claim 13, wherein the feedback estimator estimates a DC component in the downconverted signal.

16. The receiver of claim 15, wherein the feedback estimator estimates a blocking RF signal component in the downconverted signal.

17. The receiver of claim 16, wherein the feedback estimator adds the estimated blocking RF signal component and the estimated DC component.

18. The receiver of claim 17, wherein the feedback implementer comprises a sigma-delta modulator that operates on the sum of the estimated blocking RF signal component and the estimated DC component.

19. The receiver of claim 13, wherein the feedback implementer upconverts the feedback signal and couples the upconverted feedback signal to the front end amplifier.

20. The receiver of claim 19, wherein the feedback implementer couples the feedback signal to the front end amplifier input.

21. The receiver of claim 19, wherein the feedback implementer performs a logical AND operation between the feedback signal and a digital signal having a local oscillator frequency.

22. The receiver of claim 21, wherein the feedback implementer couples the feedback signal to the front end amplifier through a complex impedance.

23. The receiver of claim 21, wherein the feedback implementer couples the feedback signal to the front end amplifier through an attenuator.

24. The receiver of claim 21, wherein the feedback implementer loads the front end amplifier.

25. The receiver of claim 19, wherein the feedback implementer comprises a current steering digital to analog converter.

26. The receiver of claim 19, wherein the feedback signal is a complex signal.

27. The receiver of claim 19, further comprising an additional filter providing feedback to the front end amplifier.

28. The receiver of claim 27, wherein the additional filter provides feedback to eliminate blocker signals.

29. The receiver of claim 27, wherein the additional filter provides feedback that loads the front end amplifier.
